(19) United States
(12) Patent Application Publication
(10) Pub. No.: US 2026/0002733 A1
(43) Pub. Date: Jan. 1, 2026

(54) DRYING DEVICE AND DRYING METHOD OF DRYING DEVICE

(71) Applicants: CONTEMPORARY AMPEREX FUTURE ENERGY RESEARCH INSTITUTE (SHANGHAI) LIMITED, Shanghai (CN); CONTEMPORARY AMPEREX TECHNOLOGY CO., LIMITED, Ningde (CN)

(72) Inventors: Hong QIAO, Shanghai (CN); Guodong CHEN, Shanghai (CN); Zhaohui LIU, Shanghai (CN); Junchao CHEN, Shanghai (CN); Ke MENG, Shanghai (CN); Yongsheng GUO, Shanghai (CN)

(21) Appl. No.: 19/317,890

(22) Filed: Sep. 3, 2025

Related U.S. Application Data
(63) Continuation of application No. PCT/CN2023/081969, filed on Mar. 16, 2023.

(51) Int. Cl. F26B 9/06

(52) U.S. Cl. CPC F26B 9/06

(57) ABSTRACT

A drying device and a drying method of the drying device. The drying device includes a chamber, a heat source, a morphology detection apparatus, and a control unit. The chamber has an accommodation cavity; the accommodation cavity has a to-be-dried zone; the heat source is disposed within the accommodation cavity; a heating region of the heat source covers the to-be-dried zone; the morphology detection apparatus is disposed within the accommodation cavity; a collection region of the morphology detection apparatus covers the to-be-dried zone; the control unit is connected to the heat source and the morphology detection apparatus; and the control unit controls an operating state of the heat source based on a film surface morphology of a to-be-dried object detected by the morphology detection apparatus.

### CROSS-REFERENCE TO RELATED APPLICATION

This application is a continuation of International Application No. PCT/CN2023/081969, filed on Mar. 16, 2023, the entire content of which is incorporated herein by reference.

### TECHNICAL FIELD

This application relates to the field of manufacturing, and specifically, to a drying device and a drying method of the drying device.

### BACKGROUND

Existing drying devices exhibit undesirable drying effects when performing drying treatment on to-be-dried objects, thereby affecting the product yield rate.

Solar cells are used as an example. Solar cells are commonly prepared on glass coated with a transparent conductive film. Most organic layers are typically formed by coating. Organic sol used for coating is usually a liquid formulation solution. After coating, drying is required to evaporate the excess organic solvent to form an organic film layer. However, drying devices exhibit undesirable drying effects on existing organic sol after drying treatment, resulting in an uneven organic film layer. Therefore, improvements are needed.

### SUMMARY

In view of the above issues, this application provides a drying device and a drying method of the drying device, capable of addressing the problem of undesirable drying effects of existing drying device, which leads to uneven resulting film layers after drying.

According to a first aspect, this application provides a drying device including: a chamber having an accommodation cavity; the accommodation cavity having a to-be-dried zone; a heat source disposed within the accommodation cavity, a heating region of the heat source covering the to-be-dried zone; a morphology detection apparatus disposed within the accommodation cavity, a collection region of the morphology detection apparatus covering the to-be-dried zone; and a control unit connected to the heat source and the morphology detection apparatus. Specifically, with the above configuration, the control unit can control an operating state of the heat source (position, power, on or off, and the like) based on a film surface morphology of a to-be-dried object in the to-be-dried zone detected by the morphology detection apparatus, thereby helping to improve drying uniformity of the to-be-dried object.

In some embodiments, the heat source is provided in plurality, and heating regions of the plurality of heat sources cover different regions of the to-be-dried zone. Disposing the plurality of heat sources to cover the different regions of the to-be-dried zone implements zoned drying, thereby helping to improve drying uniformity of the to-be-dried object.

In some embodiments, the drying device further includes a temperature detection apparatus disposed within the accommodation cavity, the temperature detection apparatus being communicatively connected to the control unit. With the temperature detection apparatus disposed within the accommodation cavity, the control unit can adjust a radiation intensity of the heat source based on a detected temperature, thereby adjusting a drying speed, and helping to implement uniform drying of the to-be-dried object.

In some embodiments, the temperature detection apparatus is provided in plurality, and the plurality of temperature detection apparatuses are each communicatively connected to the control unit. With the plurality of temperature detection apparatuses disposed, the plurality of temperature detection apparatuses can be arranged in different zones, thereby improving the detection accuracy, and helping to implement uniform drying of the to-be-dried object.

In some embodiments, the heat source is provided in plurality, and each heat source is correspondingly provided with at least one temperature detection apparatus. Correspondingly providing each heat source with at least one temperature detection apparatus can implement precise temperature measurement, thereby helping to implement uniform drying of the to-be-dried object.

In some embodiments, the heat source is fixedly disposed within the accommodation cavity, or the heat source is slidably disposed within the accommodation cavity. Specifically, different connection relationships between the heat source and the accommodation cavity facilitate appropriate selection based on actual needs, thereby reducing device costs or enhancing device performance.

In some embodiments, the heat source is fixedly disposed within the accommodation cavity, and the heat source is provided in plurality; where the plurality of heat sources are uniformly distributed at a top of the accommodation cavity; or the plurality of heat sources form a plurality of heat source zones with different distribution densities at a top of the accommodation cavity. The arrangement of designing the plurality of heat sources based on actual needs facilitates device costs reduction while achieving uniform drying of the to-be-dried object.

In some embodiments, the morphology detection apparatus includes a morphology collection assembly; where the morphology collection assembly is slidably connected to the chamber, or the morphology collection assembly is fixedly connected to the chamber. Specifically, different connection relationships between the morphology collection assembly and the chamber facilitate appropriate selection based on actual needs, thereby simplifying device structure or enhancing device performance.

In some embodiments, the morphology detection apparatus includes a plurality of morphology collection assemblies, and the plurality of morphology collection assemblies are arranged by array within the accommodation cavity. Arranging the plurality of morphology collection assemblies by array facilitates collection of the film surface morphology of the to-be-dried object by the morphology collection assemblies.

In some embodiments, the plurality of morphology collection assemblies are provided in one-to-one correspondence with a plurality of temperature detection apparatuses, and one morphology collection assembly is integrated with one temperature detection apparatus. Integrating the morphology collection assemblies with the temperature detection apparatuses in a one-to-one manner can enhance the integration degree of the device, facilitate device assembly, and help to reduce device costs.

In some embodiments, the heat source includes one or more of an infrared heat source, an incandescent lamp, a tungsten halogen lamp, a hot plate, and a microwave generator. Different selections of the heat source facilitate choosing an appropriate heat source based on actual needs, thereby reducing device costs or enhancing device performance, thus improving market competitiveness.

In some embodiments, the temperature detection apparatus includes one or more of a thermocouple temperature sensor and a thermal resistance temperature sensor. This facilitates selection of the temperature detection apparatus.

In some embodiments, the chamber further includes an airflow channel communicating with an external environment and the accommodation cavity. With the airflow channel provided, the airflow channel can be configured to connect to an external device, thereby achieving a corresponding chamber environment through the external device, such as evacuating the cavity to a vacuum, which facilitates drying of the to-be-dried object.

In some embodiments, the drying device further includes a carrier apparatus disposed in the to-be-dried zone; where the heat source is spaced apart from the carrier apparatus, the carrier apparatus is located at a bottom of the accommodation cavity, the heat source is located at a top of the accommodation cavity, and the morphology detection apparatus is located between the carrier apparatus and the heat source. Specifically, the carrier apparatus is configured to support the to-be-dried object, and by arranging relative positions of the heat source, the carrier apparatus, and the morphology detection apparatus to optimize the arrangement of components within the accommodation cavity, ensuring that the components do not interfere with each other during operation.

According to a second aspect, this application provides a drying method of a drying device, applied to any one of the foregoing drying devices. The drying method includes: obtaining a film surface morphology of a to-be-dried object detected by a morphology detection apparatus; and controlling an operating state of a heat source based on the film surface morphology. Specifically, the drying method can control the operating state of the heat source based on the film surface morphology of the to-be-dried object in the to-be-dried zone detected by the morphology detection apparatus, thereby helping to improve drying uniformity of the to-be-dried object.

In some embodiments, the controlling an operating state of a heat source based on the film surface morphology includes: comparing the film surface morphology with a stored uniform and dry standard film surface morphology to obtain film surface differentiation information; and adjusting the operating state of the heat source based on the film surface differentiation information. Specifically, obtaining the film surface differentiation information by comparing with the pre-stored standard film surface morphology facilitates targeted control of the heat source to dry the to-be-dried object, thereby improving drying uniformity.

In some embodiments, the adjusting the operating state of the heat source based on the film surface differentiation information includes: adjusting, based on the film surface differentiation information, radiation intensities of heat sources corresponding to different regions of the to-be-dried object. Specifically, the radiation intensities of the heat sources corresponding to the different regions of the to-be-dried object are adjusted based on the film surface differentiation information in a targeted manner, so as to dry in a targeted manner the different regions of the to-be-dried object. This helps to improve drying uniformity of the to-be-dried object.

In some embodiments, the heat source is provided in plurality; and the controlling an operating state of a heat source based on the film surface morphology includes: controlling the heat source in a corresponding region of the to-be-dried object to heat the to-be-dried object; and controlling the heat source outside the corresponding region of the to-be-dried object to stop operating. This not only can achieve drying uniformity of the to-be-dried object, but also can reduce costs by stopping operation of the heat source outside the corresponding region of the to-be-dried object.

In some embodiments, the obtaining a film surface morphology of a to-be-dried object detected by a morphology detection apparatus includes: obtaining an image and/or a contour of the to-be-dried object detected by the morphology detection apparatus. Specifically, detecting the image and/or contour of the to-be-dried object can enable the control unit to determine a shape boundary and/or a drying degree of the to-be-dried object, so that the operating states of the plurality of heat sources are controlled in a targeted manner, thereby helping to implement uniform drying of the to-be-dried object.

In some embodiments, the method further includes: controlling, based on the film surface morphology, the heat source to move within an accommodation cavity. Specifically, the method controls, based on the film surface morphology, the heat source to move within the accommodation cavity, allowing adjustment of positions of the plurality of heat sources according to the film surface morphology of the to-be-dried object, so as to achieve an optimal arrangement of the heat sources, thereby helping to implement uniform drying of the to-be-dried object.

The above description is merely an overview of the technical solution of this application. To enable a clearer understanding of the technical means of this application and implementation according to the content of the specification, and to make the above and other objectives, features, and advantages of this application more apparent and comprehensible, specific embodiments of this application are provided below.

### BRIEF DESCRIPTION OF DRAWINGS

To describe the technical solutions in the embodiments of this application more clearly, the accompanying drawings required for describing the embodiments are briefly introduced below. Apparently, the accompanying drawings described below illustrate only some embodiments of this application, and persons of ordinary skill in the art may derive other drawings from these accompanying drawings without creative efforts.

FIG. 1 is a structural schematic diagram of an embodiment of a drying device provided by this application;

FIG. 2 is a structural schematic diagram of another embodiment of a drying device provided by this application;

FIG. 3 is a top view of an embodiment within an accommodation cavity of a drying device provided by this application;

FIG. 4 is a top view of another embodiment within an accommodation cavity of a drying device provided by this application;

FIG. 5 is a top view of another embodiment within an accommodation cavity of a drying device provided by this application;

FIG. 6 is a top view of another embodiment within an accommodation cavity of a drying device provided by this application;

FIG. 7 is a top view of another embodiment within an accommodation cavity of a drying device provided by this application;

FIG. 8 is a schematic flowchart of an embodiment of a drying method of a drying device provided by this application; and

FIG. 9 is a drying logic diagram of a drying device provided by an embodiment of this application.

### DESCRIPTION OF REFERENCE SIGNS

drying device—100;
chamber—10; accommodation cavity—101; airflow channel—102; carrier apparatus—20; heat source—30; morphology detection apparatus—40; morphology collection assembly—41; control unit—50; and temperature detection apparatus—60.

### DESCRIPTION OF EMBODIMENTS

The following clearly and completely describes the technical solutions in the embodiments of this application with reference to the accompanying drawings in the embodiments of this application. Apparently, the described embodiments are only some but not all of the embodiments of this application. All other embodiments obtained by persons of ordinary skill in the art based on the embodiments of this application without creative efforts shall fall within the protection scope of this application.

Terms “first”, “second”, and “third” in this application are used for descriptive purposes only and are not to be construed as indicating or implying relative importance or implicitly indicating the number of technical features indicated. Thus, a feature defined with “first”, “second”, or “third” may explicitly or implicitly include at least one such feature. In the description of this application, “plurality” means at least two, such as two, three, and similar quantities, unless explicitly and specifically defined otherwise. All directional indications (such as up, down, left, right, front, back, and similar directions) in the embodiments of this application are used only to explain relative positional relationships, motion conditions, and similar aspects among components in a specific posture (as shown in the drawings). If the specific posture changes, the directional indications change accordingly. Furthermore, terms “include” and “have”, as well as any variations thereof, are intended to cover non-exclusive inclusion. For example, a process, method, system, product, or apparatus including a series of steps or units is not limited to the listed steps or units but may optionally include unlisted steps or units, or optionally include other steps or units inherent to these processes, methods, products, or apparatuses.

Reference to “embodiment” herein means that a specific feature, structure, or characteristic described in connection with the embodiment may be included in at least one embodiment of this application. The word “embodiment” appearing in various places in the specification does not necessarily refer to the same embodiment or an independent or alternative embodiment that is exclusive of other embodiments. Persons skilled in the art explicitly and implicitly understand that the embodiments described herein may be combined with other embodiments.

In the description of the embodiments of this application, the term “and/or” merely describes an association relationship between associated objects, indicating three possible relationships. For example, A and/or B may indicate: A exists alone, A and B exist simultaneously, and B exists alone. Additionally, the character “/” herein generally indicates an “or” relationship between the associated objects before and after the character.

In the description of the embodiments of this application, the term “plurality” refers to more than two (including two). Similarly, “multiple groups” refers to more than two groups (including two groups), and “multiple pieces” refers to more than two pieces (including two pieces).

In the description of the embodiments of this application, unless otherwise specified and defined explicitly, the terms “mount”, “connect”, “join”, and “fasten” should be understood in their general senses. For example, they may refer to a fixed connection, a detachable connection, or an integral connection, may refer to a mechanical connection or electrical connection, and may refer to a direct connection, an indirect connection via an intermediate medium, or an interaction between two elements. Persons of ordinary skill in the art can understand the specific meanings of the above terms in the embodiments of this application based on specific circumstances.

Solar cells are devices that utilize the photoelectric conversion principle to convert solar radiation into electrical energy through semiconductor materials, a process commonly referred to as the “photovoltaic effect”. Hence, solar cells are also known as “photovoltaic cells”. Currently, from the perspective of market development, the application of solar cells is increasingly widespread. Solar cells are not only applied in energy storage power systems but also widely used in electric vehicles and other electric transportation means, as well as in military equipment, aerospace, and various other fields. With the continuous expansion of application fields for solar cells, market demand continues to grow significantly.

The preparation of solar cells typically includes a step of applying an organic film layer formed by an organic sol formulation solution onto glass coated with a transparent conductive film. Forming the organic film layer from the organic sol formulation solution requires drying to evaporate excess organic solvent, and the drying evaporation process demands that the resulting organic film layer be highly uniform.

However, the inventors of this application have found:
1. The industrialized size of solar cells is relatively large, and existing drying device mostly employ airflow field for drying, making uniform drying difficult to achieve.
2. Considering adaptation to different solar cell product specifications, when cell dimensions change, it is difficult for a heat field in a single zone to meet uniform drying conditions.

Existing drying devices generally include components capable of generating radiant heat and/or components generating airflow, achieving drying of to-be-dried objects through radiant heat and flowing airflow. Such devices are widely applied in the manufacturing field, such as in the fields of display panel manufacturing and solar cell preparation.

To address the issue of uneven drying of to-be-dried objects by existing drying devices, the applicant has revealed through research that heat fields in different zones can be controlled within a drying device and a film surface morphology of a to-be-dried object can be obtained so as to control, based on the film surface morphology of the to-be-dried object, a corresponding heat field to dry the to-be-dried object, thereby achieving uniform drying.

Based on the above considerations, to solve the problem of uneven drying of to-be-dried objects by existing drying devices, the inventors propose the following technical solution after thorough research.

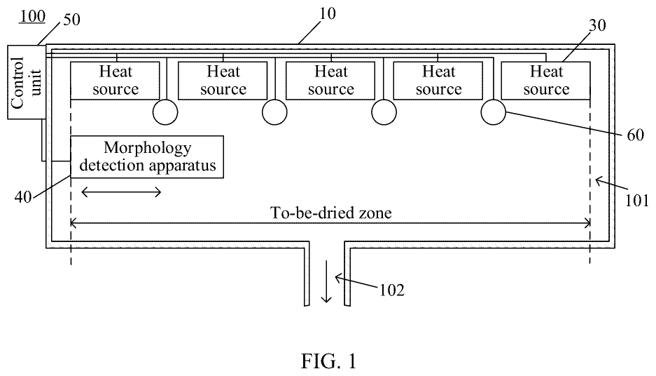

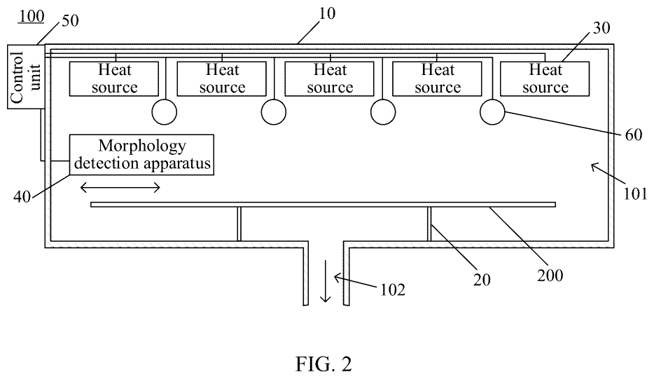

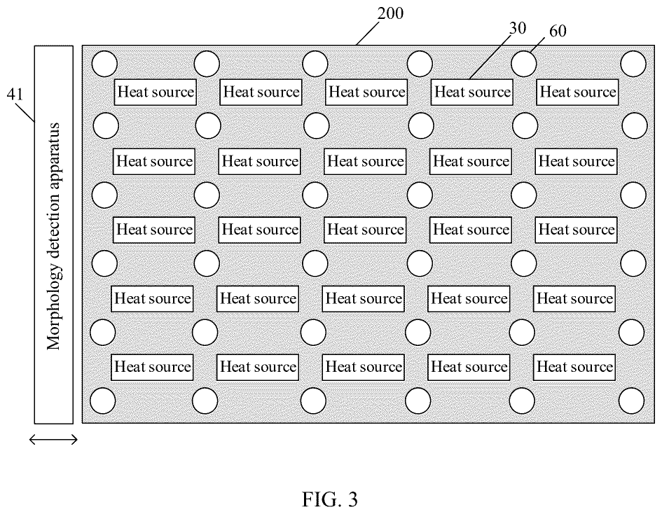

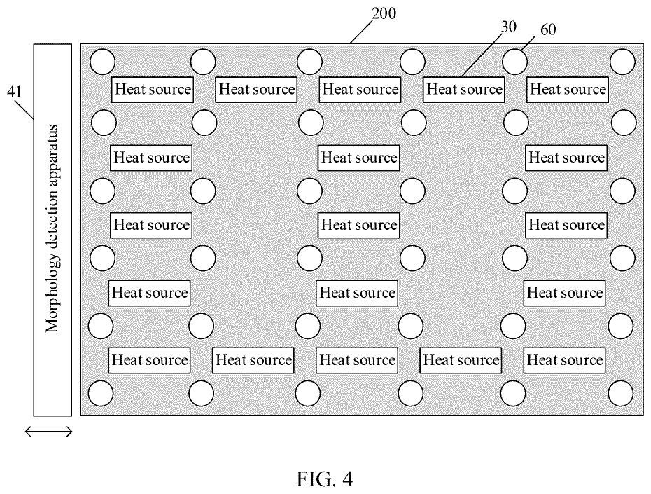

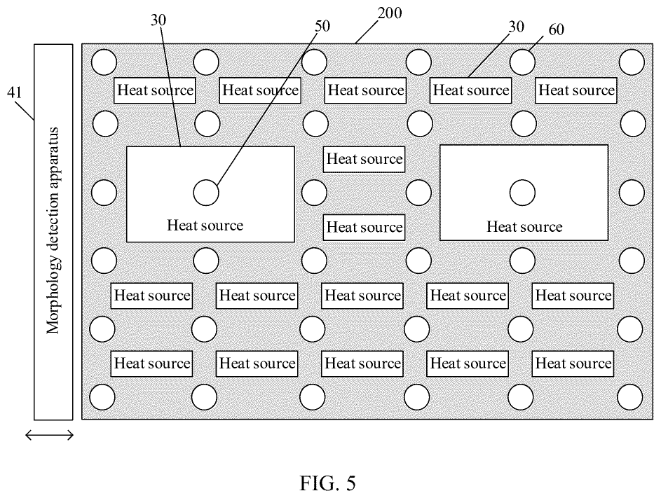

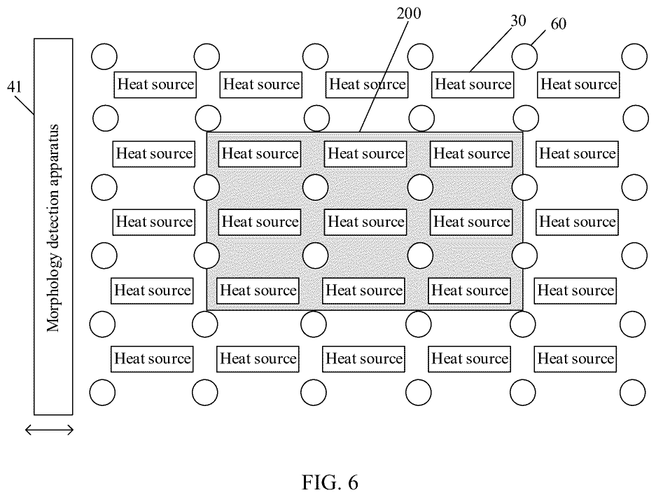

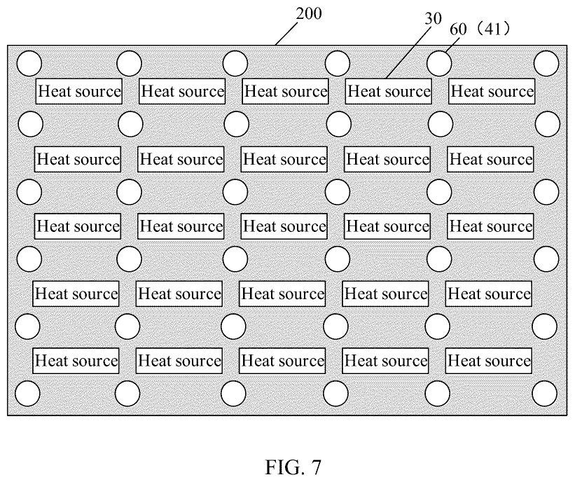

Refer to FIGS. 1-7. FIG. 1 is a structural schematic diagram of an embodiment of a drying device provided by this application; FIG. 2 is a structural schematic diagram of another embodiment of a drying device provided by this application; FIG. 3 is a top view of an embodiment within an accommodation cavity of a drying device provided by this application; FIG. 4 is a top view of another embodiment within an accommodation cavity of a drying device provided by this application; FIG. 5 is a top view of another embodiment within an accommodation cavity of a drying device provided by this application; FIG. 6 is a top view of another embodiment within an accommodation cavity of a drying device provided by this application; and FIG. 7 is a top view of another embodiment within an accommodation cavity of a drying device provided by this application.

This application designs a drying device 100 including a chamber 10, a heat source 30, a morphology detection apparatus 40, and a control unit 50. The chamber 10 has an accommodation cavity 101, and the accommodation cavity 101 has a to-be-dried zone. The heat source 30 is disposed within the accommodation cavity 101, and a heating region of the heat source 30 covers the to-be-dried zone and is configured to release heat in an operating condition to dry a to-be-dried object 200 located in the to-be-dried zone. The morphology detection apparatus 40 is disposed within the accommodation cavity 101, and a collection region of the morphology detection apparatus 40 covers the to-be-dried zone and is configured to perform detection for a film surface morphology of the to-be-dried object 200 located in the to-be-dried zone. The control unit 50 is connected to both the heat source 30 and the morphology detection apparatus 40. The control unit 50 controls an operating state of the heat source 30 based on the film surface morphology of the to-be-dried object 200 detected by the morphology detection apparatus 40, thereby controlling the heat source 30 to form a targeted heat field to achieve uniform drying of the to-be-dried object 200.

The chamber 10 refers to a housing of the device formed with an accommodation space. In this application, the chamber 10 is formed with the accommodation cavity 101, and the accommodation cavity 101 is configured to accommodate the heat source 30, the morphology detection apparatus 40, and the to-be-dried object 200. A shape and a size of the chamber 10 are not limited and can be designed as needed. In this application, the chamber 10 is a metal housing.

The heat source 30 refers to a component capable of releasing thermal energy in an operating condition, such as a lamp with heat radiation, an infrared light source, or a microwave generator. The heat source 30 may be provided in plurality, and the plurality of heat sources 30 may be multiple independent heat sources 30 arranged with or without spacing. Alternatively, the plurality of heat sources 30 may be a single heat source apparatus containing multiple independently controllable heat release regions, with the multiple heat release regions representing the plurality of heat sources 30. Alternatively, one heat source 30 may be provided, and the one heat source 30 is slidably connected to the chamber 10, allowing the one heat source 30 to be movably disposed within the accommodation cavity 101.

The to-be-dried zone is a region covered by thermal energy released by the heat source 30 in an operating condition, and the to-be-dried zone is configured to accommodate the to-be-dried object 200, allowing the heat source 30 to dry the to-be-dried object 200 during operation.

The to-be-dried object 200 is a substance requiring drying treatment, such as a film layer to be cured, a liquid, a semi-solid, or a solid material containing a certain content of liquid. The to-be-dried object 200 includes, but is not limited to, the foregoing organic sol formulation solution in this application. When the to-be-dried object 200 is located in the to-be-dried zone, the to-be-dried object 200 needs to be supported to some degree. For example, the to-be-dried object 200 can be supported by a substrate (such as a glass substrate), and then the substrate is placed in the to-be-dried zone. In this application, the to-be-dried object 200 is transparent conductive glass coated with an organic sol formulation solution.

The morphology detection apparatus 40 refers to a device that obtains the film surface morphology of the to-be-dried object 200 through scanning or imaging. Specifically, with the morphology detection apparatus 40 performing detection for the film surface morphology of the to-be-dried object 200, the control unit 50 can obtain a shape and/or a drying degree of the to-be-dried object 200, and control the operating state of the heat source 30 in a targeted manner based on the film surface morphology, thereby facilitating uniform drying of the to-be-dried object 200.

The control unit 50 generally includes a processor and a memory. The processor may also be referred to as a CPU (Central Processing Unit, central processing unit). The processor may be an integrated circuit chip with signal processing capabilities. The processor may alternatively be a general-purpose processor, a digital signal processor (DSP), an application-specific integrated circuit (ASIC), a field-programmable gate array (FPGA), or other programmable logic devices, a discrete gate or transistor logic device, or a discrete hardware component. The general-purpose processor may be a microprocessor, or the processor may be any conventional processor or the like. The memory may be a memory stick, a TF card, or the like, capable of storing all information in the device, including input raw data, a computer program, an intermediate operation result, and a final operation result, all of which are stored in the memory. The memory stores and retrieves information based on locations specified by the processor. With the memory, the control unit 50 has a memory function, ensuring normal operation. In this application, the control unit 50 is disposed on an outer side surface of the chamber 10, or may be disposed outside the chamber 10 and spaced apart from the chamber 10, with no limitation specified herein.

Specifically, when the drying device 100 dries the to-be-dried object 200, the to-be-dried object 200 is first transferred to the to-be-dried zone within the accommodation cavity 101 using a mechanical gripper arm, a conveyor belt, or a similar mechanism, and then the accommodation cavity 101 is sealed. The morphology detection apparatus 40 performs detection for the film surface morphology of the to-be-dried object 200, and the control unit 50 controls an operating state of one or more heat sources 30 based on the film surface morphology detected by the morphology detection apparatus 40; alternatively, the control unit 50 compares the film surface morphology detected by the morphology detection apparatus 40 with a stored uniform and dry standard film surface morphology to obtain film surface differentiation information, and then controls the operating state of one or more heat sources 30 based on the film surface differentiation information. The control unit 50 controlling the operating state of one heat source 30 includes controlling the heat source 30 to move to a target position within the accommodation cavity 101, adjusting an operating power of the one heat source 30, and similar actions to dry the to-be-dried object 200; the control unit 50 controlling the operating states of the plurality of heat sources 30 includes turning on and off some heat sources 30, adjusting radiation intensities of the plurality of heat sources 30, and similar actions. After a period of drying treatment, a uniformly dried film surface is obtained, and finally, the uniformly dried to-be-dried object 200 is removed from the accommodation cavity 101 for standby use. The control unit 50 controlling the operating states of the plurality of heat sources 30 includes turning on and off some heat sources 30, adjusting operating powers of the plurality of heat sources 30, and similar actions, forming corresponding heat field regions within the accommodation cavity 101 to dry the to-be-dried object 200. After a period of drying treatment, a uniformly dried film surface is obtained, and finally, the uniformly dried to-be-dried object 200 is removed from the accommodation cavity 101 for standby use.

It can be understood that this application performs detection for the film surface morphology of the to-be-dried object 200 through the morphology detection apparatus 40, and the control unit 50 controls the operating state of the heat source 30 based on film surface information detected by the morphology detection apparatus 40, forming a targeted heat field according to the film surface morphology of the to-be-dried object 200 to achieve uniform drying of the to-be-dried object 200. Therefore, when addressing the issue of uneven drying for large-sized and/or differently sized solar cells, the drying device 100 provided by this application can perform detection for the film surface morphology in real-time through the morphology detection apparatus 40, and compare the film surface morphology with a standard uniformly dried film surface morphology. For differentiated morphology, the control unit 50 controls the operating state of the heat source 30, such as adjusting an operating power of the heat source 30 in a corresponding region, thereby achieving uniform drying of the entire film surface. Since the to-be-dried object 200 in this application is a two-dimensional film with a small thickness dimension, drying uniformity of the to-be-dried object 200 is primarily in a direction parallel to the film of the to-be-dried object 200, that is, the horizontal direction. Thus, this application divides the accommodation cavity 101 into multiple drying regions along the horizontal direction, with each drying region correspondingly provided with one or more heat sources 30, or different drying regions are dried by a single movable heat source 30.

In some embodiments, optionally, the heat source 30 is provided in plurality, and the control unit 50 controls the heat sources 30 corresponding to a region of the to-be-dried object 200 to heat and dry the to-be-dried object 200, and controls the heat sources 30 outside the corresponding region of the to-be-dried object 200 to stop operating.

Each heat source 30 releases heat covering a certain region of the to-be-dried object 200 during operation, and this region is a corresponding region of the heat source 30 and the to-be-dried object 200. The heat sources 30 corresponding to the region of the to-be-dried object 200 refer to all heat sources 30 whose released heat covers the to-be-dried object 200 during operation.

Specifically, an initial state of the plurality of heat sources 30 may be all on, all off, or partially on and partially off. When the to-be-dried object 200 is supported on the carrier apparatus 20, the morphology detection apparatus 40 performs detection for the film surface morphology of the to-be-dried object 200, and the control unit 50 obtains a contour of the to-be-dried object 200 based on the film surface morphology detected by the morphology detection apparatus 40, thereby controlling the heat sources 30 corresponding to the region of the to-be-dried object 200 to heat and dry the to-be-dried object 200, and controlling the heat sources 30 outside the corresponding region of the to-be-dried object 200 to stop operating, that is, controlling the heat sources 30 outside the corresponding region of the to-be-dried object 200 not to operate. This not only achieves targeted uniform drying of the to-be-dried object 200 but also reduces drying costs.

The initial state of the plurality of heat sources 30 may be all on, meaning that when the to-be-dried object 200 is not in the to-be-dried zone or has just entered the to-be-dried zone, the plurality of heat sources 30 are in an operating state, allowing drying operations to begin immediately upon the to-be-dried object 200 entering the accommodation cavity 101, thereby improving drying efficiency.

The initial state of the plurality of heat sources 30 may be all off, meaning that when the to-be-dried object 200 is not in the to-be-dried zone or has just entered the to-be-dried zone, the plurality of heat sources 30 are not operating, thereby saving costs and reducing energy waste.

The initial state of the plurality of heat sources 30 may be partially on and partially off. For example, the initial state of the plurality of heat sources 30 may be a final state from a previous drying operation, or some heat sources 30 may be turned on or off in advance based on an estimated shape of the to-be-dried object 200. After the control unit 50 obtains the film surface morphology of the to-be-dried object 200, some heat sources 30 are turned on or off for adjustment, thereby improving drying efficiency while saving costs.

When the heat source 30 is provided as a single unit, if the heat source 30 is located outside the corresponding region of the to-be-dried object 200, the control unit 50 controls the heat source 30 to move from outside the corresponding region of the to-be-dried object 200 to the corresponding region of the to-be-dried object 200 and activates the heat source 30 to uniformly dry the to-be-dried object 200. If the heat source 30 is located within the corresponding region of the to-be-dried object 200, the control unit 50 controls the heat source 30 to activate to uniformly dry the to-be-dried object 200.

For ease of description, the following description assumes the heat source 30 is provided in plurality.

In some embodiments, optionally, the control unit 50 adjusts radiation intensities of the heat sources 30 corresponding to the region of the to-be-dried object 200 to dry the to-be-dried object.

Specifically, the radiation intensity of the heat source 30 is positively correlated with an operating power of the heat source 30, meaning that a higher operating power of the heat source 30 results in greater radiation intensity and a higher temperature generated by the released thermal energy, and vice versa.

In this application, the control unit 50 adjusts the radiation intensity of the heat sources 30 corresponding to the region of the to-be-dried object 200 based on the film surface morphology detected by the morphology detection apparatus 40 or based on film surface differentiation information obtained through comparison, thereby drying the to-be-dried object 200 in a targeted manner and improving drying uniformity of the to-be-dried object 200.

It can be understood that when drying the to-be-dried object 200, drying conditions (such as temperature) may differ at different stages, or drying degrees may vary across different regions of the same to-be-dried object 200. Therefore, the control unit 50 adjusts the radiation intensity of the heat sources 30 corresponding to the region of the to-be-dried object 200 based on the film surface morphology detected by the morphology detection apparatus 40 or the film surface differentiation information obtained through comparison, forming a targeted heat field. This allows changing a drying temperature of the to-be-dried object at different stages or providing different drying temperatures to different regions of the same to-be-dried object 200, thereby improving drying uniformity of the to-be-dried object 200.

In some embodiments, optionally, the film surface morphology includes an image and/or a contour of the to-be-dried object.

The image refers to a surface morphology of the to-be-dried object 200, which may be a two-dimensional or three-dimensional image. For example, the image may reflect a drying degree, in-plane texture, in-plane wrinkles, in-plane unevenness, and similar features of the to-be-dried object 200.

The contour refers to a boundary or outline forming any shape.

In this application, detecting the morphology and/or contour of the to-be-dried object 200 through the morphology detection apparatus 40 enables the control unit 50 to determine a shape boundary and/or a drying degree of the to-be-dried object, thereby controlling operating states of the plurality of heat sources 30 in a targeted manner. For example, the control unit 50 controls the plurality of heat sources 30 within the shape boundary of the to-be-dried object 200 to operate based on the contour of the to-be-dried object 200, and controls the plurality of heat sources 30 outside the shape boundary of the to-be-dried object not to operate, thereby saving drying costs; alternatively, the control unit 50 adjusts the radiation intensity of the heat sources 30 corresponding to different drying regions of the to-be-dried object 200 based on the morphology of the to-be-dried object 200, forming a targeted heat field for regions with different drying degrees to facilitate uniform drying of the to-be-dried object 200.

In some embodiments, optionally, refer to FIG. 2, the drying device 100 further includes a carrier apparatus 20 disposed in the to-be-dried zone; where the heat source 30 is spaced apart from the carrier apparatus 20, the carrier apparatus 20 is located at a bottom of the accommodation cavity 101; the heat source 30 is located at a top of the accommodation cavity 101; and the morphology detection apparatus 40 is located between the carrier apparatus 20 and the heat source 30.

The carrier apparatus 20 is configured to provide a stable supporting plane for the to-be-dried object 200. Specifically, the carrier apparatus 20 may be an object with a supporting plane or may consist of multiple supporting columns forming a supporting plane, as long as the to-be-dried object 200 can be stably supported on the carrier apparatus 20.

Specifically, the carrier apparatus 20 is configured to support the to-be-dried object 200 and ensure that the to-be-dried object 200 is located in the to-be-dried zone during drying treatment. The plurality of heat sources 30 may be disposed on a surface of the carrier apparatus 20 configured to support the to-be-dried object 200, in contact with the to-be-dried object 200, to increase a drying speed; alternatively, the plurality of heat sources 30 may be disposed within the carrier apparatus 20, and a material of the carrier apparatus 20 may have good thermal conductivity, with the heat sources 30 transferring heat indirectly to the to-be-dried object 200 by heating the carrier apparatus 20. In the above configuration, heat released by the heat sources 30 is transferred to the to-be-dried object 200 at a high rate, thereby improving drying efficiency. Additionally, disposing the plurality of heat sources 30 within the carrier apparatus 20 or on the surface of the carrier apparatus 20 enhances the integration degree of the device and does not affect an installation space of other components (such as the morphology detection apparatus 40).

Spaced apart means that a certain distance exists between the heat source 30 and the carrier apparatus 20 without contact. A structure of the carrier apparatus 20 is not limited and may include a platform or a bracket, with the platform or bracket having a supporting plane. Specifically, spacing the heat source 30 from the carrier apparatus 20 facilitates separate installation or replacement of the heat source 30 or the carrier apparatus 20.

A top and a bottom of the accommodation cavity 101 refer to two opposing regions within the accommodation cavity 101, with the bottom being a region of the cavity space closer to the ground and the top being a region of the cavity space farther from the ground. Disposing the carrier apparatus 20 at the bottom of the accommodation cavity 101 facilitates supporting the to-be-dried object 200, and disposing the heat source 30 at the top of the accommodation cavity 101, opposite and spaced from the carrier apparatus 20, does not affect drying of the to-be-dried object 200 supported on the carrier apparatus 20 by the heat source 30. The morphology detection apparatus 40, disposed between the carrier apparatus 20 and the heat source 30, allows the morphology detection apparatus 40 to perform detection for the film surface morphology of the to-be-dried object 200 supported on the carrier apparatus 20 below without interference from the heat source 30. For example, when the morphology detection apparatus 40 employs a sliding scanning detection method, the heat source 30 and the carrier apparatus 20 do not obstruct a sliding path during sliding of the morphology detection apparatus 40. Additionally, when the heat source 30 dries the to-be-dried object 200, the morphology detection apparatus 40 can slide toward a sidewall of the accommodation cavity 101, ensuring that the morphology detection apparatus 40 does not block the heat source 30.

Specifically, optimizing an arrangement of the heat source 30, the morphology detection apparatus 40, and the carrier apparatus 20 within the accommodation cavity 101 ensures that the components do not interfere with each other during operation.

In some embodiments, optionally, the heat source 30 is provided in plurality, and heating regions of the plurality of heat sources 30 cover different regions of the to-be-dried zone.

Specifically, disposing the plurality of heat sources 30 with the plurality of heat sources 30 covering different regions of the to-be-dried zone achieves zoned drying, thereby helping to improve drying uniformity of the to-be-dried object. For example, if drying degrees differ across different film surface regions of the same to-be-dried object 200, the control unit 50 adjusts radiation intensities of the heat sources 30 corresponding to the different film surface regions based on the different film surface regions of the to-be-dried object 200, forming a targeted heat field, thereby improving drying uniformity.

In some embodiments, optionally, refer to FIG. 1, the drying device 100 further includes a temperature detection apparatus 60 disposed within the accommodation cavity 101, and the temperature detection apparatus 60 is communicatively connected to the control unit 50.

The temperature detection apparatus 60 refers to a device configured to perform detection for a temperature of a test environment, a test object, or similar subjects. In this application, the temperature detection apparatus 60 is configured to perform detection for a temperature within the accommodation cavity 101 and/or a film surface temperature of the to-be-dried object 200 and outputs a detection result to the control unit 50 via wired transmission or wireless communication.

In this application, with the temperature detection apparatus 60 disposed within the accommodation cavity 101, the temperature detection apparatus 60 may be mounted within the accommodation cavity 101 via a bracket or a suspension rod. For example, a lifting rod is installed on a top wall of the accommodation cavity 101, the temperature detection apparatus 60 is fixed to a bottom end of the lifting rod, and the lifting rod can position the temperature detection apparatus 60 at different height regions. It can be understood that the closer the temperature detection apparatus 60 is to the to-be-dried object 200, the closer a detected temperature is to the film surface temperature of the to-be-dried object 200. The temperature detection apparatus 60 is configured to sense a temperature in a located region and convert the temperature into an available output signal for the control unit 50, enabling the control unit 50 to adjust a radiation intensity of a corresponding heat source 30 based on the temperature of a certain region detected by the temperature detection apparatus 60, so that the temperature in that region falls within a preset temperature range, thereby achieving uniform drying.

In some embodiments, optionally, the temperature detection apparatus 60 is provided in plurality; and the plurality of temperature detection apparatuses 60 are each communicatively connected to the control unit 50.

Specifically, during a drying process of the to-be-dried object 200, sensitivity may vary across different film surface regions of the to-be-dried object 200. For example, under the same operating power of the heat source 30, some regions may dry quickly while others dry more slowly. Therefore, to achieve uniform drying, this application disposes the plurality of temperature detection apparatuses 60 arranged in different zones, with each drying region provided with at least one temperature detection apparatus 60 to improve temperature detection accuracy. The control unit 50 can compare the film surface morphology detected by the morphology detection apparatus 40 with a stored uniform and dry standard film surface morphology to obtain film surface differentiation information, and based on the differentiation information and a temperature detected by the temperature detection apparatus 60 in a corresponding region, adjust an operating power of the heat source 30 in the corresponding region, such as increasing a radiation intensity of the heat source 30 in a region with a slower drying speed to raise a drying temperature and accelerate a drying speed, or reducing a radiation intensity of the heat source 30 in a region with a faster drying speed to lower a drying temperature and slow a drying speed, thereby achieving uniform drying. It can be understood that “uniform drying” in this application does not mean maintaining a consistent temperature in every region but rather adjusting a local temperature based on varying sensitivity of different film surface regions of the to-be-dried object 200 under an overall consistent drying temperature, making an overall drying effect of the to-be-dried object 200 more uniform.

Specifically, the drying device 100 provided by this application, by disposing the morphology detection apparatus 40, the plurality of heat sources 30, and the plurality of temperature detection apparatuses 60, enables the control unit 50 to control operating states of the plurality of heat sources 30 and adjust radiation intensities of the plurality of heat sources 30 individually based on relevant information detected by the morphology detection apparatus 40 and the plurality of temperature detection apparatuses 60, achieving uniform drying speed and ultimately obtaining a uniformly dried film layer.

In some embodiments, optionally, the heat source 30 is provided in plurality, and at least one temperature detection apparatus 60 is correspondingly disposed on a side of each heat source 30 closer to the carrier apparatus 20.

Specifically, since each heat source 30 has a certain light-emitting area, heat released by each heat source 30 during operation covers a certain region. In this application, disposing at least one temperature detection apparatus 60 on the side of each heat source 30 closer to the carrier apparatus 20 enables more precise detection of a temperature within a heat release region of each heat source 30, thereby facilitating more accurate control of an operating power of the heat source 30 by the control unit 50 to achieve uniform drying.

In some embodiments, optionally, the heat source 30 is fixedly disposed within the accommodation cavity 101, or the heat source 30 is slidably disposed within the accommodation cavity 101.

Specifically, different connection relationships between the heat source 30 and the accommodation cavity 101 facilitate appropriate selection based on actual needs, thereby reducing device costs or enhancing device performance.

Disposing the plurality of heat sources 30 slidably within the accommodation cavity 101 allows the control unit 50 to control the plurality of heat sources 30 to move within the accommodation cavity 101 based on the film surface morphology of the to-be-dried object 200 detected by the morphology detection apparatus 40, adjusting positions of the plurality of heat sources 30 within the accommodation cavity 101 to achieve an optimal arrangement of the heat sources 30 and enhance device performance. Furthermore, the control unit 50 can further control operating states of the plurality of heat sources 30, thereby controlling the heat sources 30 to form a targeted heat field to achieve uniform drying of the to-be-dried object 200.

For example, the control unit 50 can control the plurality of heat sources 30 to move based on different sensitivities of different film surface regions, forming heat sources 30 with different distribution densities in different film surface regions, thereby correspondingly increasing or decreasing a drying speed in a corresponding region. It can be understood that a higher distribution density of the heat sources 30 results in a higher drying speed, while a lower distribution density of the heat sources 30 results in a lower drying speed.

Alternatively, the control unit 50 can control the plurality of heat sources 30 to move based on an image and/or contour of the to-be-dried object 200, causing the plurality of heat sources 30 to form a distribution pattern corresponding to the image and/or contour of the to-be-dried object 200. For example, if the to-be-dried object 200 is circular, the control unit 50 controls the plurality of heat sources 30 to move to form a corresponding circular drying region. Alternatively, if the to-be-dried object 200 is rectangular, the control unit 50 controls the plurality of heat sources 30 to move to form a corresponding rectangular drying region.

Specifically, the control unit 50 controls the plurality of heat sources 30 to move to change an arrangement density of the plurality of heat sources 30 in different regions and/or form a distribution pattern corresponding to the film surface morphology of the to-be-dried object, enhancing device performance and facilitating uniform drying of the to-be-dried object 200.

A method for the control unit 50 to control movement of the heat source 30 may involve disposing a slide groove at the top of the accommodation cavity 101, with the heat source 30 connected to the slide groove via a pulley, and the control unit 50 controlling movement of the pulley to control movement of the heat source 30 within the accommodation cavity 101. Alternatively, a transport mechanism movable relative to the top of the accommodation cavity 101 is disposed at the top of the accommodation cavity 101, the heat source 30 is suspended on the transport mechanism, and the control unit 50 controls movement of the transport mechanism to move the plurality of heat sources within the accommodation cavity 101. Specifically, a method for the control unit 50 to control movement of the heat source 30 is not limited and may employ existing technologies as long as the above objective is achieved.

Alternatively, disposing the plurality of heat sources 30 fixedly within the accommodation cavity 101 forms fixed heat field regions with the plurality of heat sources 30, resulting in a simple device structure that reduces costs.

In some embodiments, optionally, the heat source 30 is fixedly disposed within the accommodation cavity 101, and the heat source 30 is provided in plurality; where the plurality of heat sources 30 are uniformly distributed at a top of the accommodation cavity 101; or the plurality of heat sources 30 form a plurality of heat source zones with different distribution densities at the top of the accommodation cavity 101.

Specifically, refer to FIG. 3. The plurality of heat sources 30 are fixed at the top of the accommodation cavity 101 and uniformly distributed at the top of the accommodation cavity 101, improving temperature uniformity and facilitating uniform drying. In this embodiment, the temperature detection apparatus 60 is circular, and the heat source 30 is rectangular; the plurality of heat sources 30 are arranged in a two-dimensional array, the plurality of temperature detection apparatuses 60 are also arranged in a two-dimensional array, multiple rows of heat sources 30 alternate with multiple rows of temperature detection apparatuses 60, multiple columns of heat sources 30 alternate with multiple columns of temperature detection apparatuses 60, and one temperature detection apparatus 60 is disposed at each of four corner positions of each heat source 30.

Specifically, refer to FIG. 4. Based on a sensitivity of the to-be-dried object 200 (film layer), under the premise of ensuring uniform drying, the plurality of heat sources 30 may be fixed at the top of the accommodation cavity 101, and the plurality of heat sources 30 form a plurality of heat source zones with different distribution densities at the top of the accommodation cavity 101 to form different drying regions, thereby forming different temperature fields during drying operations. It can be understood that a higher distribution density of the heat sources 30 results in a faster drying speed for the to-be-dried object 200, and vice versa. If different regions of the same drying object have different sensitivities, and different sensitivities result in different drying speeds at the same temperature, forming a plurality of heat source zones with different distribution densities creates different temperature fields for different sensitive regions during drying operations, achieving consistent drying speeds across different sensitive regions. This can significantly reduce device complexity and ultimately lower device costs while ensuring uniform drying.

In some embodiments, optionally, orthogonal projection areas of light-emitting areas of the plurality of heat sources 30 on a bottom of the accommodation cavity 101 differ.

The light-emitting area may characterize a size of the heat source 30, with different light-emitting areas representing different sizes of the heat sources 30. It can be understood that heat sources 30 with different light-emitting areas or heat sources 30 with the same light-emitting area but different arrangement methods (such as tilted arrangement) form different heat release regions on the to-be-dried object 200 during operation, capable of drying different regions of the to-be-dried object 200. A larger orthogonal projection area of a light-emitting area of a single heat source 30 on the bottom of the accommodation cavity 101 results in a larger heat release region formed on the to-be-dried object 200, with less precise temperature adjustment in that corresponding region; a smaller orthogonal projection area of a light-emitting area of a single heat source 30 on the bottom of the accommodation cavity 101 results in a smaller heat release region formed on the to-be-dried object 200, with more precise temperature adjustment in that corresponding region. When a film layer to be dried of the to-be-dried object 200 is a patterned film layer with patterns of different shapes and areas, the heat sources 30 corresponding to each pattern of the film layer to be dried adopt different arrangement methods and/or light-emitting areas, enabling uniform drying of each pattern of the film layer to be dried.

A size of each heat source 30 may be as small as 1 cm*1 cm or much larger. A shape of the heat source 30 may be designed based on actual needs, such as rectangular, circular, diamond-shaped, or other polygonal shapes, with no limitation specified herein.

Specifically, refer to FIG. 5. A light-emitting surface of the heat source 30 described in FIG. 5 is arranged parallel to the to-be-dried object 200. Based on a sensitivity of the to-be-dried object 200 (film layer), under the premise of ensuring uniform drying, a size of a light-emitting area of the heat source 30 may be set independently. For example, sizes of the plurality of heat sources 30 in a local region are smaller to more precisely adjust an operating power of the heat sources 30 in that region, thereby adjusting a drying temperature, while sizes of the plurality of heat sources 30 in a region with less precise temperature requirements may be larger. This significantly reduces apparatus complexity and ultimately lowers device costs while ensuring uniform drying.

In some embodiments, optionally, the morphology detection apparatus 40 includes a morphology collection assembly 41; where the morphology collection assembly 41 is slidably connected to the chamber 10; or the morphology collection assembly 41 is fixedly connected to the chamber 10.

Slidable connection means that the morphology collection assembly 41 can move relative to the chamber 10 on an inner surface of the chamber 10 under control of the control unit 50 or another external force.

Specifically, different connection relationships between the morphology collection assembly 41 and the chamber 10 facilitate appropriate selection based on actual needs, thereby reducing device costs or enhancing device performance.

Refer to FIGS. 3-6. The morphology collection assembly 41 is slidable relative to an inner surface of the chamber 10, facilitating collection of the film surface morphology of the to-be-dried object 200. The morphology collection assembly 41 may be a scanning morphology collection assembly 41, such as a scanner, or an imaging morphology collection assembly 41, such as a camera. When the morphology detection apparatus 40 performs detection for the film surface morphology of the to-be-dried object 200, the morphology collection assembly 41 can slide to collect or reciprocally scan and capture the to-be-dried object 200, obtaining a real-time film surface morphology of the to-be-dried object 200, enhancing apparatus collection performance, and transmitting the morphology to the control unit 50 for corresponding operations.

In some embodiments, one of the morphology collection assembly 41 and an inner surface of the chamber 10 is provided with a slide rail (not shown), and the other is provided with a slide groove (not shown), with the morphology collection assembly 41 and the chamber 10 slidably connected via the slide rail and the slide groove. Alternatively, the inner surface of the chamber 10 is provided with a transport mechanism (not shown) movable relative to the chamber 10, the morphology collection assembly 41 is connected to the transport mechanism, and the morphology collection assembly 41 and the chamber 10 are slidably connected via the transport mechanism. Specifically, the slidable connection methods provided above for the morphology collection assembly 41 and the chamber 10 are simple in structure and easy to implement.

In other embodiments, the morphology collection assembly 41 and the chamber 10 are fixedly connected, and the morphology collection assembly 41 collects the film surface morphology of the to-be-dried object 200 at a fixed angle. It can be understood that fixing the morphology collection assembly 41 to the chamber 10 eliminates the need for a complex sliding mechanism within the chamber 10, simplifying the device structure.

In some embodiments, optionally, the morphology detection apparatus 40 includes a plurality of morphology collection assemblies 41, and the plurality of morphology collection assemblies 41 are arranged by array within the accommodation cavity 101.

Specifically, refer to FIG. 7. The plurality of morphology collection assemblies 41 arranged by array may be cameras, and the plurality of morphology collection assemblies 41 may be fixedly disposed to collect a real-time film surface morphology of the to-be-dried object 200, which is then transmitted to the control unit 50 for corresponding operations.

Specifically, slidably disposing the morphology collection assembly 41 within the accommodation cavity 101, or arranging the plurality of morphology collection assemblies 41 in an array within the accommodation cavity 101, facilitates selection of the morphology detection apparatus 40.

In some embodiments, optionally, the plurality of morphology collection assemblies 41 are provided in one-to-one correspondence with a plurality of temperature detection apparatuses 60, and one morphology collection assembly 41 is integrated with one temperature detection apparatus 60. Integrating the morphology collection assemblies 41 with the temperature detection apparatuses 60 in a one-to-one manner enhances the integration degree of the device, facilitates device assembly, and reduces device costs.

Specifically, refer to FIG. 7. The plurality of morphology collection assemblies 41 and the plurality of temperature detection apparatuses 60 are both distributed within the accommodation cavity 101, and one morphology collection assembly 41 and one temperature detection apparatus 60 are integrated into a single device. This device can not only perform detection for a portion of the film surface morphology of the to-be-dried object 200 below but also perform detection for a temperature of a corresponding region, enhancing the integration degree of the device and reducing device costs.

In some embodiments, optionally, the heat source 30 includes one or more of an infrared heat source, an incandescent lamp, a tungsten halogen lamp, a hot plate, and a microwave generator.

The heat transfer form of the infrared heat source is radiative heat transfer, transferring energy via electromagnetic waves. When infrared rays irradiate the to-be-dried object 200, a portion of the rays is reflected back, and a portion runs through. When a wavelength of emitted infrared rays matches an absorption wavelength of the to-be-dried object 200, the to-be-dried object 200 absorbs the infrared rays, causing molecules and atoms within the object to resonate, producing strong vibration and rotation. The vibration and rotation increase a temperature of the object, achieving the purpose of drying.

The incandescent lamp is an electric light source that heats a filament to an incandescent state through electric current, emitting visible light using thermal radiation. Thus, due to light emission via thermal radiation, the incandescent lamp has a certain heat release effect and can be used as the heat source 30.

The tungsten halogen lamp is an inflatable incandescent lamp filled with a gas containing some halogen elements or halides. To keep halides generated at a lamp wall in a gaseous state, a wall temperature of the tungsten halogen lamp is much higher than that of a regular incandescent lamp. Therefore, the tungsten halogen lamp has a certain heat release effect and can be used as the heat source 30.

The microwave generator converts electrical energy into microwave energy at a rated frequency, thereby providing a heat release effect.

The hot plate may be a heat source structure formed in a plate shape from the aforementioned infrared heat source, incandescent lamp, tungsten halogen lamp, or microwave generator, or the hot plate may be a resistance plate configured to generate heat under electrification to achieve a heat release function.

Specifically, the various types of heat sources 30 described above facilitate selection by users based on actual needs, allowing selection of an appropriate heat source according to actual requirements, thereby reducing device costs or enhancing device performance and improving market competitiveness.

In some embodiments, optionally, the temperature detection apparatus 60 includes one or more of a thermocouple temperature sensor and a thermal resistance temperature sensor.

The thermocouple temperature sensor is configured to directly measure a temperature and convert a temperature signal into a thermoelectromotive force signal, which is then converted into a temperature of a measured medium through an electrical instrument (secondary instrument). A basic principle of temperature measurement with the thermocouple temperature sensor is that two conductors of different materials form a closed loop. When a temperature gradient exists at both ends, a current flows through the loop, generating an electromotive force (thermoelectromotive force) between the two ends, known as the Seebeck effect.

The thermal resistance temperature sensor is a sensor thermometer that measures temperature based on a principle that a resistance value of a conductor or semiconductor changes with temperature. Thermal resistance temperature sensors are divided into two categories: metal thermal resistors and semiconductor thermistors. Thermal resistors are widely used to measure temperatures in a range of −200° C. to +850° C., and in rare cases, low temperatures can be measured down to 1K, and high temperatures up to 1000° C. The thermal resistance sensor consists of a thermal resistor, connecting wires, and a display instrument. The thermal resistor may also be connected to a temperature transmitter to convert a temperature into a standard current signal output.

Specifically, the different types of temperature detection apparatuses 60 described above facilitate selection by users based on actual needs, achieving the purpose of measuring temperatures in different regions within the accommodation cavity 101.

In some embodiments, optionally, the chamber 10 further includes an airflow channel 102 communicating with an external environment and the accommodation cavity 101.

The airflow channel 102 refers to a channel usable for gas flow. The airflow channel may be configured to connect to external device to achieve a corresponding chamber environment through the external device.

For example, the external device may be vacuum evacuation equipment configured to evacuate the accommodation cavity 101 to create a vacuum environment. Evacuation refers to extracting and discharging gas from a specific space, resulting in a pressure less than one atmosphere relative to the atmosphere, commonly referred to as a vacuum in that specific space. Equipment used for evacuation is referred to as vacuum evacuation equipment, such as a vacuum pump.

Specifically, the chamber 10 in the drying device 100 provided by this application further includes the airflow channel 102 connecting the external environment and the accommodation cavity 101, enabling realization of a corresponding environment of the chamber 10 based on actual needs during drying operations, such as evacuating the accommodation cavity 101 to place the drying device 100 under vacuum conditions, thereby facilitating drying of the to-be-dried object 200.

The drying device 100 provided by this application includes the chamber 10, the heat source 30, the morphology detection apparatus 40, and the control unit 50; where the chamber 10 has the accommodation cavity 101, and the accommodation cavity 101 has the to-be-dried zone; the heat source 30 and the morphology detection apparatus 40 are disposed within the accommodation cavity 101, and when the to-be-dried object 200 is placed in the to-be-dried zone, the morphology detection apparatus 40 performs detection for the film surface morphology of the to-be-dried object 200; the control unit 50 is respectively connected to the heat source 30 and the morphology detection apparatus 40; the control unit 50 controls an operating state of the heat source 30 based on the film surface morphology of the to-be-dried object 200 detected by the morphology detection apparatus 40, achieving uniform drying of the to-be-dried object 200. Further, the drying device 100 also includes the temperature detection apparatus 60 disposed within the accommodation cavity 101 and connected to the control unit 50, configured to perform detection for temperatures in different regions within the accommodation cavity 101 during the drying process, enabling the control unit 50 to adjust a radiation intensity of the heat source 30 in a certain region based on a current temperature of that region detected by the temperature detection apparatus 60, so that the temperature in that region falls within a preset temperature range, thereby achieving the purpose of uniform drying.

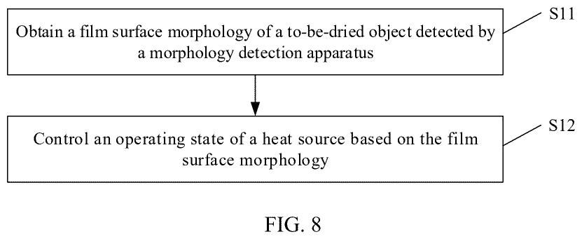

Referring to FIG. 8, FIG. 8 is a schematic flowchart of an embodiment of a drying method of a drying device provided by this application. Specifically, this application further provides a drying method of a drying device 100, applied to the drying device 100 provided in any of the above embodiments. The drying method includes:

Step S11: Obtain a film surface morphology of a to-be-dried object 200 detected by a morphology detection apparatus 40.

Specifically, a control unit 50 is connected to the morphology detection apparatus 40. When the to-be-dried object 200 is supported on a carrier apparatus 20, the control unit 50 obtains the film surface morphology of the to-be-dried object 200 detected by the morphology detection apparatus 40.

Step S12: Control an operating state of a heat source 30 based on the film surface morphology.

Specifically, the control unit 50 is also connected to the heat source 30. The control unit 50 controls the operating state of the heat source 30 based on the film surface morphology of the to-be-dried object 200 detected by the morphology detection apparatus 40, thereby controlling the heat source 30 to form a targeted heat field to achieve uniform drying of the to-be-dried object 200.

One or more heat sources 30 may be provided. The control unit 50 controlling the operating states of the plurality of heat sources 30 includes turning on and off some heat sources 30, adjusting radiation intensities of a plurality of heat sources 30, and the like. The control unit 50 controlling the operating state of one heat source 30 includes controlling the heat source 30 to move to a target position within the accommodation cavity 101, adjusting a radiation intensity of the heat source 30, and the like.

Specifically, the drying method can control the operating state of the heat source 30 based on the film surface morphology of the to-be-dried object 200 placed in the to-be-dried zone detected by the morphology detection apparatus 40, thereby helping to improve drying uniformity of the to-be-dried object.

For ease of description, the following description assumes that the heat source 30 is provided in plurality.

In some embodiments, optionally, step S12 includes: comparing the film surface morphology with a stored uniform and dry standard film surface morphology to obtain film surface differentiation information; and adjusting the operating state of the heat source 30 based on the film surface differentiation information.

Specifically, the control unit 50 may also pre-store the uniform and dry standard film surface morphology of the to-be-dried object 200, so as to compare with the film surface morphology of the to-be-dried object 200 detected by the morphology detection apparatus 40 to obtain the film surface differentiation information between the detected film surface morphology and the standard film surface morphology, so as to control the operating state of the plurality of heat sources 30.

Specifically, obtaining the film surface differentiation information by comparing the film surface morphology with the pre-stored standard film surface morphology helps to control in a target manner the plurality of heat sources 30 to dry the to-be-dried object 200, thereby improving drying uniformity.

In some embodiments, optionally, the adjusting the operating state of the heat source based on the film surface differentiation information includes: adjusting, based on the film surface differentiation information, radiation intensities of the heat source 30 corresponding to different regions of the to-be-dried object 200.

The radiation intensity of the heat source 30 is positively correlated with an operating power of the heat source 30, meaning that a higher operating power of the heat source 30 results in a greater radiation intensity and a higher temperature generated by released thermal energy, and vice versa.

A heat source 30 whose released heat during operation can cover a portion of a region of the to-be-dried object 200 is a heat source 30 corresponding to that region of the to-be-dried object 200. An orthogonal projection of a light-emitting surface of a heat source 30 corresponding to a different region of the to-be-dried object 200 may completely overlap with that region. For example, the heat source 30 is located directly above or below the different region of the to-be-dried object 200. An orthogonal projection of a light-emitting surface of the heat source 30 corresponding to a different region of the to-be-dried object 200 may alternatively partially overlap or do not overlap at all with that region. For example, the heat source 30 is located diagonally above or below the different region of the to-be-dried object 200, as long as the heat released during operation can cover a portion of a region of the to-be-dried object 200, a heat source 30 is considered the heat source 30 corresponding to that region, with no limitation specified herein.

In this application, the control unit 50 adjusts, based on the film surface morphology detected by the morphology detection apparatus 40 or the film surface differentiation information obtained through comparison, the radiation intensities of the heat sources 30 corresponding to the different regions of the to-be-dried object 200, so as to dry the different regions of the to-be-dried object 200 in a targeted manner based on the film surface morphologies of the different regions, thereby improving drying uniformity of the to-be-dried object 200.

It can be understood that in drying the to-be-dried object 200, drying conditions (such as temperature) may differ at different stages, or drying degrees may vary across different regions of the same to-be-dried object 200. Therefore, the control unit 50 adjusts, based on the film surface morphology detected by the morphology detection apparatus 40 or the film surface differentiation information obtained through comparison, the radiation intensities of the heat sources 30 corresponding to the different regions of the to-be-dried object 200, so as to form targeted heat fields. This can allow changing a drying temperature of the to-be-dried object at different stages or providing different drying temperatures to the different regions of the same to-be-dried object 200, thereby improving drying uniformity of the to-be-dried object 200.

In some embodiments, optionally, the heat source 30 is provided in plurality; and the controlling an operating state of a heat source 30 based on the film surface morphology includes: controlling the heat sources 30 in a corresponding region of the to-be-dried object 200 to heat the to-be-dried object; and controlling the heat sources 30 outside the corresponding region of the to-be-dried object 200 to stop operating.

Specifically, the initial states of the plurality of heat sources 30 may be all on, all off, or partially on and partially off. When the to-be-dried object 200 is supported on the carrier apparatus 20, the morphology detection apparatus 40 performs detection for the film surface morphology of the to-be-dried object 200, and the control unit 50 obtains a contour of the to-be-dried object 200 based on the film surface morphology detected by the morphology detection apparatus 40.

If the initial states of the plurality of heat sources 30 are all on, the control unit 50 controls the heat sources 30 outside the corresponding region of the to-be-dried object 200 to stop operating.

If the initial states of the plurality of heat sources 30 are all off, the control unit 50 controls the heat sources 30 in the corresponding region of the to-be-dried object 200 to operate to heat the to-be-dried object 200.

If the initial states of the plurality of heat sources 30 are partially on and partially off, the control unit 50 controls the heat sources 30 in the corresponding region of the to-be-dried object 200 to operate to heat the to-be-dried object 200; and controls the heat source 30 outside the corresponding region of the to-be-dried object 200 to stop operating.

Specifically, the control unit 50 controls the heat sources 30 in the corresponding region of the to-be-dried object 200 to operate to dry the to-be-dried object 200; and controls the heat source 30 outside the corresponding region of the to-be-dried object 200 to stop operating, thereby not only achieving targeted uniform drying of the to-be-dried object but also reducing drying costs.

In some embodiments, optionally, step S11 includes: obtaining an image and/or a contour of the to-be-dried object 200 detected by the morphology detection apparatus 40.

Specifically, the image refers to a surface morphology of the to-be-dried object 200, which may be a two-dimensional or three-dimensional image. For example, the image may reflect a drying degree, in-plane texture, in-plane wrinkles, in-plane unevenness, and the like of the to-be-dried object 200. The contour is a boundary or outline forming any shape.

In this application, the control unit 50 obtains the morphology and/or contour of the to-be-dried object 200 detected by the morphology detection apparatus 40, enabling the control unit 50 to determine a shape boundary and/or a drying degree of the to-be-dried object, thereby controlling the operating states of the plurality of heat sources 30 in a targeted manner. For example, the control unit 50 controls, based on the contour of the to-be-dried object 200, a plurality of heat sources 30 within the shape boundary of the to-be-dried object 200 to operate, and controls a plurality of heat sources 30 outside the shape boundary of the to-be-dried object not to operate, thereby saving drying costs. Alternatively, the control unit 50 controls, based on the morphology of the to-be-dried object 200, operating powers of the heat sources 30 corresponding to different drying regions of the to-be-dried object 200, forming targeted heat fields for regions with different drying degrees to facilitate uniform drying of the to-be-dried object 200.

In some embodiments, optionally, the drying method further includes: controlling, based on the film surface morphology, the plurality of heat sources 30 to move within an accommodation cavity 101.

In this application, disposing the plurality of heat sources 30 movably within the accommodation cavity 101 allows the control unit 50 to control, based on the film surface morphology of the to-be-dried object 200 detected by the morphology detection apparatus 40, the plurality of heat sources 30 to move within the accommodation cavity 101, so as to adjust positions of the plurality of heat sources 30 within the accommodation cavity 101 to achieve an optimal arrangement of the heat sources 30. In this way, the operating states of the plurality of heat sources 30 are further controlled, thereby controlling the heat sources 30 to form targeted heat fields to achieve uniform drying of the to-be-dried object 200.

For example, the control unit 50 can control the plurality of heat sources 30 to move based on different sensitivities of different film surface regions, forming heat sources 30 with different distribution densities in different film surface regions, thereby correspondingly increasing or decreasing a drying speed in a corresponding region. It can be understood that a higher distribution density of the heat sources 30 results in a higher drying speed, while a lower distribution density of the heat sources 30 results in a lower drying speed.

Alternatively, the control unit 50 can control the plurality of heat sources 30 to move based on an image and/or contour of the to-be-dried object 200, causing the plurality of heat sources 30 to form a distribution pattern corresponding to the image and/or contour of the to-be-dried object 200. For example, if the to-be-dried object 200 is circular, the control unit 50 controls the plurality of heat sources 30 to move to form a corresponding circular drying region. Alternatively, if the to-be-dried object 200 is rectangular, the control unit 50 controls the plurality of heat sources 30 to move to form a corresponding rectangular drying region.

Specifically, the control unit 50 controls the plurality of heat sources 30 to move to change an arrangement density of the plurality of heat sources 30 in different regions and/or form a distribution pattern corresponding to the film surface morphology of the to-be-dried object, thereby facilitating uniform drying of the to-be-dried object 200.

The drying method provided by this application enables the control unit 50 to obtain the film surface morphology of the to-be-dried object 200 detected by the morphology detection apparatus 40 and control an operating state of the heat source 30 based on the film surface morphology, such as turning on and off some heat sources 30, adjusting an operating power of the heat source 30, and similar actions, forming corresponding heat field regions within the accommodation cavity 101, thereby achieving uniform drying of the to-be-dried object 200.

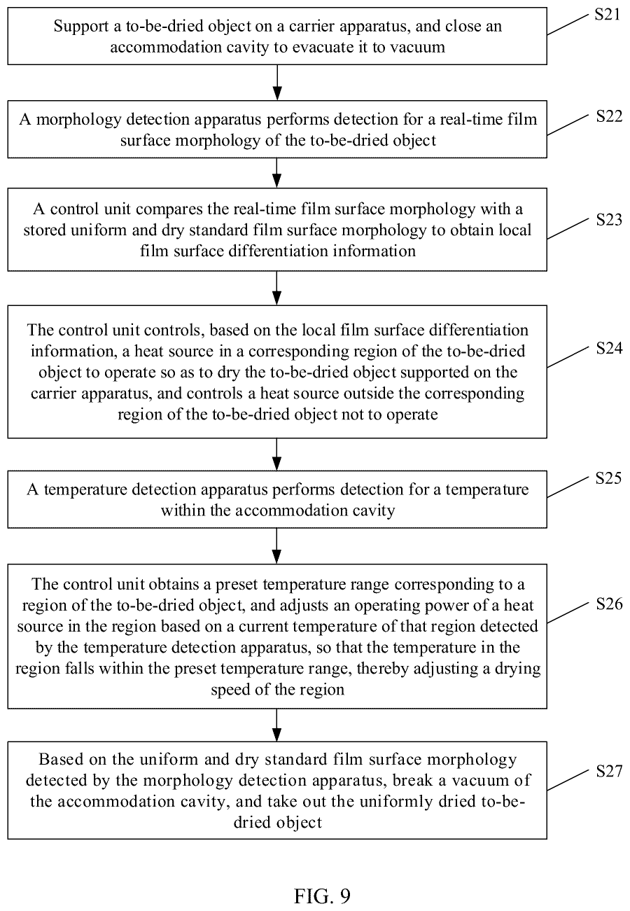

In a specific embodiment of this application, the drying device 100 includes the chamber 10, the carrier apparatus 20, the plurality of heat sources 30, the morphology detection apparatus 40, the temperature detection apparatus 60, and the control unit 50 described above. Refer to FIG. 9, FIG. 9 is a drying logic diagram of the drying device provided by an embodiment of this application, and a drying logic of the drying device 100 includes:

Step S21: Support a to-be-dried object on the carrier apparatus, and close the accommodation cavity to evacuate it to vacuum.

Step S22: The morphology detection apparatus performs detection for a real-time film surface morphology of the to-be-dried object.

Step S23: The control unit compares the real-time film surface morphology with a stored uniform and dry standard film surface morphology to obtain local film surface differentiation information.

Step S24: The control unit controls, based on the local film surface differentiation information, a heat source in a corresponding region of the to-be-dried object to operate so as to dry the to-be-dried object supported on the carrier apparatus, and controls a heat source outside the corresponding region of the to-be-dried object not to operate.

Step S25: The temperature detection apparatus performs detection for a temperature within the accommodation cavity.

Step S26: The control unit obtains a preset temperature range corresponding to a region of the to-be-dried object, and adjusts an operating power of a heat source in the region based on a current temperature of that region detected by the temperature detection apparatus, so that the temperature in the region falls within the preset temperature range, thereby adjusting a drying speed of the region.

Step S27: Based on the uniform and dry standard film surface morphology detected by the morphology detection apparatus, break a vacuum of the accommodation cavity, and take out the uniformly dried to-be-dried object.

Finally, it should be noted that the above embodiments are provided only to illustrate the technical solution of this application and not to limit it; although this application has been described in detail with reference to the foregoing embodiments, persons of ordinary skill in the art should understand that they may still modify the technical solutions described in the foregoing embodiments or perform equivalent replacements to some or all of the technical features thereof; such modifications or replacements do not cause the essence of the corresponding technical solutions to depart from the scope of the technical solutions of the embodiments of this application, and they should all be encompassed within the scope of the claims and the specification of this application. In particular, as long as there is no structural conflict, the various technical features mentioned in the embodiments can be combined in any manner. This application is not limited to the specific embodiments disclosed herein but includes all technical solutions falling within the scope of the claims.

What is claimed is:

1. A drying device, comprising:
a chamber having an accommodation cavity, the accommodation cavity having a to-be-dried zone;
a heat source disposed within the accommodation cavity, a heating region of the heat source covering the to-be-dried zone;
a morphology detection apparatus disposed within the accommodation cavity, a collection region of the morphology detection apparatus covering the to-be-dried zone; and
a control unit connected to the heat source and the morphology detection apparatus.

2. The device according to claim 1, wherein the heat source is one of a plurality of heat sources of the device, and heating regions of the plurality of heat sources cover different regions of the to-be-dried zone.

3. The device according to claim 1, further comprising:
a temperature detection apparatus disposed within the accommodation cavity, the temperature detection apparatus being communicatively connected to the control unit.

4. The device according to claim 3, wherein the temperature detection apparatus is one of a plurality temperature detection apparatuses each communicatively connected to the control unit.

5. The device according to claim 4, wherein the heat source is one of a plurality of heat sources each correspondingly provided with at least one temperature detection apparatus.

6. The device according to claim 3, wherein the temperature detection apparatus comprises one or more of a thermocouple temperature sensor and a thermal resistance temperature sensor.

7. The device according to claim 1, wherein the heat source is fixedly disposed within the accommodation cavity, or the heat source is slidably disposed within the accommodation cavity.

8. The device according to claim 1, wherein:
the heat source is one of a plurality of heat sources fixedly disposed within the accommodation cavity; and
the plurality of heat sources are uniformly distributed at a top of the accommodation cavity, or form a plurality of heat source zones with different distribution densities at a top of the accommodation cavity.

9. The device according to claim 1, wherein:
the morphology detection apparatus comprises a morphology collection assembly; and
the morphology collection assembly is slidably or fixedly connected to the chamber.

10. The device according to claim 1, wherein the morphology detection apparatus comprises a plurality of morphology collection assemblies, and the plurality of morphology collection assemblies are arranged by array within the accommodation cavity.

11. The device according to claim 10, wherein the plurality of morphology collection assemblies are provided in one-to-one correspondence with a plurality of temperature detection apparatuses, and one morphology collection assembly is integrated with one temperature detection apparatus.

12. The device according to claim 1, wherein the heat source comprises one or more of an infrared heat source, an incandescent lamp, a tungsten halogen lamp, a hot plate, and a microwave generator.

13. The device according to claim 1, wherein the chamber further comprises an airflow channel communicating with an external environment and the accommodation cavity.

14. The device according to claim 1, further comprising:
a carrier apparatus disposed in the to-be-dried zone;
wherein the heat source is spaced apart from the carrier apparatus, the carrier apparatus is located at a bottom of the accommodation cavity, the heat source is located at a top of the accommodation cavity, and the morphology detection apparatus is located between the carrier apparatus and the heat source.

15. A drying method applied to the drying device according to claim 1, comprising:
obtaining a film surface morphology of the to-be-dried object detected by the morphology detection apparatus; and
controlling an operating state of the heat source based on the film surface morphology.

16. The drying method according to claim 15, wherein controlling the operating state of the heat source based on the film surface morphology comprises:
comparing the film surface morphology with a stored uniform and dry standard film surface morphology to obtain film surface differentiation information; and
adjusting the operating state of the heat source based on the film surface differentiation information.

17. The drying method according to claim 16, wherein adjusting the operating state of the heat source based on the film surface differentiation information comprises:
adjusting, based on the film surface differentiation information, radiation intensities of heat sources corresponding to different regions of the to-be-dried object.

18. The drying method according to claim 15, wherein:
the heat source is one of a plurality of heat sources of the drying device; and
controlling the operating state of the heat source based on the film surface morphology comprises:
controlling the heat source in a corresponding region of the to-be-dried object to heat the to-be-dried object; and
controlling the heat source outside the corresponding region of the to-be-dried object to stop operating.

19. The drying method according to claim 15, wherein obtaining the film surface morphology of the to-be-dried object detected by the morphology detection apparatus comprises:
obtaining an image and/or a contour of the to-be-dried object detected by the morphology detection apparatus.

20. The drying method according to claim 15, further comprising:
controlling, based on the film surface morphology, the heat source to move within an accommodation cavity.
